(19) United States
(12) Patent Application Publication
(10) Pub. No.: US 2025/0272565 A1
(43) Pub. Date: Aug. 28, 2025

(54) Autonomous LLM Agent Systems and Methods

(71) Applicant: Google LLC, Mountain View, CA (US)

(72) Inventor: John James Lunney, Zürich (CH)

(21) Appl. No.: 18/585,709

(22) Filed: Feb. 23, 2024

(51) Int. Cl. G06N 3/09; G06N 3/0455

(52) U.S. Cl. CPC G06N 3/09; G06N 3/0455

(57) ABSTRACT

The technology provides an approach to fine-tune an autonomous large language model (LLM)-based agent for question-answering in an electronic messaging context. This approach can include obtaining incoming electronic messages that each include a question, and obtaining responsive electronic messages that each include an answer to the question. The system correlates each responsive electronic message with a given incoming electronic message as a question-answer thread. The question-answer thread can be routed for each message pair to an agent training module, which performs training of an LLM using a set of the questions-answer threads as inputs to learn an answer that addresses the question. The resultant trained LLM can then be stored in a database of the system. Then, when an incoming electronic message with a question is received from a user, the trained LLM can generate a responsive electronic message according to the learned answer that addresses the question.

### BACKGROUND

Email and other complex, unstructured communication can be challenging to parse and manage, especially in situations where correspondence can be routed to different people. For instance, a significant aspect of a knowledge business, such as technical support, can involve question answering. A number of people may be able to provide different levels of support, or expertise on specific issues. Thus, when a request for assistance is received, making sure it is passed to the correct person is important-both to the person requesting assistance and the organization that provides it. Improper distribution can be time-consuming and wasteful. Moreover, poor distribution can result in the organization failing to address the issue for which support is requested.

### BRIEF SUMMARY

One aspect of the technology provides an approach to fine-tune an autonomous large language model (LLM)-based agent for question-answering in an electronic messaging context. This can include scenarios with a shared mailbox or other type of common message repository accessible by different personnel. Here, question-answer training can be used to create an agent that can handle basic or otherwise routine queries, such as for an IT or HR support ticket queue. Once trained, the autonomous LLM agent can operate in a way that frees up human support personnel to handle more complex or atypical issues. Another scenario enables creation of a bespoke agent tailored according to a particular user's electronic messages. Such an agent may function as a virtual assistant for that user.

As discussed in detail below, autonomous LLM agent training can be done using messages obtained directly from an email or other messaging pipeline. This would eliminate the need for manually created training data. The messages may be preprocessed to remove certain portions, such as signatures, quoted text and/or other extraneous content (e.g., attachments). The system can then match questions to answers using message timestamps to train a Q&A prompt-response. The trained agent can then be used to handle routine queries or often-asked questions, which can free up human experts to address more complex situations.

According to one aspect of the technology, a method is provided that comprises: obtaining, by one or more processors of a computing system, incoming electronic messages from corresponding users, the incoming electronic messages each including a question; obtaining, by one or more processors of the computing system, responsive electronic messages to the corresponding users, the responsive electronic messages each including an answer to the question; correlating, by one or more processors of the computing system, each responsive electronic message with a given one of the incoming electronic messages as a question-answer thread; routing, by one or more processors of the computing system, the question-answer thread for each correlated incoming and responsive electronic message pair to an agent training module of the computing system; performing, by one or more processors of the computing system using the agent training module, training of a large language model using a set of the questions-answer threads as inputs to learn an answer that addresses the question; and storing the trained large language model in a database of the computing system.

In one example, the correlating includes tracking each given incoming electronic message and each responsive electronic message for a selected amount of time; and prior to routing the question-answer thread for each correlated incoming and responsive electronic message pair to the agent training module, discarding any subsequent messaged in that question-answer thread obtained after the selected amount of time. In another example, the correlating includes adding any new incoming message or new responsive message to a related question-answer thread when the new incoming or responsive messages are obtained before a dormancy threshold has been reached.

Alternatively or additionally to any of the above, the training of the large language model comprises fine-tuning a previously trained model for a specific question-answer situation. The responsive electronic messages are obtained from a shared inbox or group email address, or, alternatively, the responsive electronic messages are associated with a single person. In the latter case, the trained large language model may be configured for use as a virtual assistant for the single person.

Alternatively or additionally to any of the above, the method may further comprise preprocessing one or more of the incoming electronic messages or responsive electronic messages to remove selected information therefrom. Here, removing the selecting information may include at least one of removing a signature block, removing quoted text, or removing an attachment.

Alternatively or additionally to any of the above, performing the training may include discarding a learned answer that does not satisfy a question-answer criterion.

According to another aspect of the technology, a method is provided that comprises: receiving, by an electronic messaging system, an incoming electronic message from a user, the incoming electronic messages including a question; routing, by the electronic messaging system, the incoming electronic message to trained autonomous agent, the trained autonomous agent comprising a large language model trained using a set of actual questions-answer threads as inputs to learn an answer that addresses the question; and generating, by one or more processors of the electronic messaging system, a responsive electronic message according to the learned answer that addresses the question.

In one example, this method further comprises creating, by the trained autonomous agent, a proposed answer to the question; and evaluating, by the one or more processors using a scorer module, the proposed answer. Here, when evaluating determines that the proposed answer does not satisfy a threshold criterion, the method may further include: discarding the generated responsive electronic message; and forwarding the incoming electronic message to a specific inbox or email address for manual answer generation. And when evaluating determines that the proposed answer does satisfy a threshold criterion, the method may further include causing the generated responsive electronic message to be transmitted to the user.

According to a further aspect of the technology, a system is provided that comprises an electronic message module, a thread processing module, and an agent training module. The electronic message module is configured to obtain incoming electronic messages from corresponding users, the incoming electronic messages each including a question, and to obtain responsive electronic messages to the corresponding users, the responsive electronic messages each including an answer to the question. The thread processing module is configured to correlate each responsive electronic message with a given one of the incoming electronic messages as a question-answer thread. And the agent training module is configured to receive the question-answer thread for each correlated incoming and responsive electronic message pair, the agent training module being configured to train a large language model using a set of the questions-answer threads as inputs to learn an answer that addresses the question, and to store the trained large language model in a database of the computing system.

The correlation may include tracking each given incoming electronic message and each responsive electronic message for a selected amount of time, and for a subsequent messaged in a given question-answer thread obtained after the selected amount of time, the thread processing module may be configured to discard the subsequent message.

Alternatively or additionally to any of the above, the correlation may include addition of any new incoming message or new responsive message to a related question-answer thread when the new incoming or responsive messages are obtained before a dormancy threshold has been reached. Alternatively or additionally to any of the above, the agent training module may be configured to train the large language model by fine-tuning a previously trained model for a specific question-answer situation. Alternatively or additionally to any of the above, the system is further configured to preprocess one or more of the incoming electronic messages or responsive electronic messages to remove selected information therefrom. Alternatively or additionally to any of the above, performance of the training includes discarding a learned answer that does not satisfy a question-answer criterion.

### BRIEF DESCRIPTION OF THE DRAWINGS

FIG. 1 illustrates an example scenario in accordance with aspects of the technology.

FIG. 2 illustrates a Transformer-type architecture for use in accordance with aspects of the technology.

FIG. 3 illustrates an example training system in accordance with aspects of the technology.

FIG. 4 illustrates another example training system, which can be used to train on messages associated with a single person, in accordance with aspects of the technology.

FIGS. 5A-B illustrate examples for question-answer scoring, in accordance with aspects of the technology.

FIGS. 6A-B illustrate a system for use with aspects of the technology.

FIG. 7 illustrates a method in accordance with aspects of the technology.

FIG. 8 illustrates another method in accordance with aspects of the technology.

### DETAILED DESCRIPTION

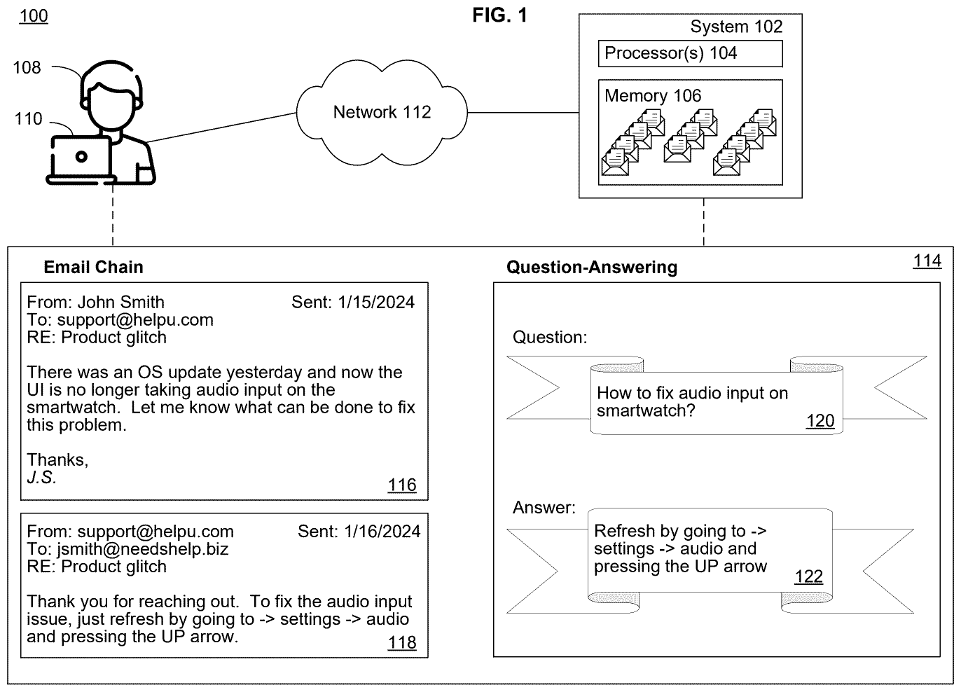

Before discussing training and implementation of an autonomous LLM-based agent for question-answering, an exemplary scenario is presented that shows how question-answering may be handled by a person responding to email queries. In particular, FIG. 1 illustrates an example messaging scenario 100, in which a user sends an electronic message (in this example an email message), to a support service. Computing system 102 may be part of a company's on-line support service. As shown, the computing system 102 includes one or more processors 104 and memory 106 for storing data. In one example, the memory 106 may store information corresponding to a plurality of email question-answer threads. By way of example, this may include one or more message queues, where each incoming and outgoing message has a corresponding timestamp for when it was received or sent. The system 102 may receive queries from users 108 via the users' devices 110 and a communication network 112, such as the Internet. While only one user 108 and one user device 110 are shown, there may be many such users and devices (e.g., tens, hundreds, thousands or more).

Section 114 of the scenario 100 illustrates two aspects of a question-answer message thread. One aspect is the message chain itself (e.g., an email chain as shown). On the left side of section 114 are messages 116 and 118. Message 116 is, in this example, an email from a user 108 regarding an issue with a product (“Product glitch” per the “RE” line of the email message). In particular, the message states “There was an OS update yesterday and now the UI is no longer taking audio input on the smartwatch. Let me know what can be done to fix this problem.” The email message 116 may be routed to member of the support team for the support service, such as an IT specialist that handles smartwatch OS issues. Message 118 is a response from the support team member, routed via computing system 102. In particular, the response states “Thank you for reaching out. To fix the audio input issue, just refresh by going to→settings→audio and pressing the UP arrow.”

The right side of section 115 illustrates the other aspect of the question-answer thread, which is identification of the question and determination of a correct answer to that question. Note that the email message 116 does not pose the user's question as “How do I fix the smartwatch UI to take audio input?” Rather, the first sentence is a statement of the issue, and the second sentence is statement asking how to “fix this problem”. Thus, it may be necessary in this type of situation to determine the actual question from the input message. In this example, determined question 120 is “How to fix audio input on smartwatch?”. Based on this question, a derived answer 122 may be “Refresh by going to→settings→audio and pressing the UP arrow”, which can then be sent to the user via email message 118.

Ideally, the incoming message 116 would be routed directly to the correct support agent, who is able to determine the actual question, derive an answer, and promptly respond to the user. However, if the message 116 goes to a shared mailbox such as a support ticket queue, it may be picked up by a support team member who is unfamiliar with smartwatch OS issues. Also, there may be a delay in ultimately routing the message 116 to the right person to derive the correct answer. In addition, it is likely that if one person had the smartwatch OS issue, that many others will also have the same issue. Thus, the shared mailbox may receive many messages about this issue, even if users phrase the issue differently. This could overwhelm the ability of the human support agents to handle these and other issues.

In view of this, an autonomous LLM-based agent may be fine-tuned or otherwise trained on question-answering message chains. This agent may be tasked to deal with certain high frequency and/or basic/routine questions, taking them out of the support ticket queue. This could enable human agents to address more complicated or “one-off” type issues, without getting inundated by other messages.

Given this, the present technology will now be described with respect to the following exemplary systems and methods.

In one scenario, the system may determine what the question is and derive an answer for that question based on a machine learning LLM. In particular, the system can use a large “foundation” (e.g., a baseline) language model, and then build a “fine-tuning” on top of that. The foundation model “knows” or otherwise understands language in general, from training over a very large data set. The fine-tuning does not need to learn different ways of phrasing a question; rather, it may be configured to learn the specifics of a business situation (or other) situational context. The model may employ, by way of example, a Transformer-type architecture, a convolutional neural network (CNN), recurrent neural network (RNN), long short-term memory (LSTM) network or combination thereof. For instance, the machine learning model may employ a Transformer-type machine learning architecture as discussed in U.S. Pat. No. 10,452,978, entitled “Attention-based sequence transduction neural networks”, the entire disclosure of which is incorporated herein by reference.

The machine learning model may be trained to identify key points in the emails, extracting questions and answers to those questions from a received email query and a corresponding answering email. The machine learning model may further be trained to map questions to one or more relevant answers. In one scenario, fine-tuning may employ a Low-rank adaptation (LoRA) approach. This is an adapter-based technique used to fine-tune models. LoRA reduces the computational burden, allowing faster adaptation of models. This approach may employ significantly fewer trainable parameters than the underlying model, which can make it more computationally efficient to fine-tune an LLM.

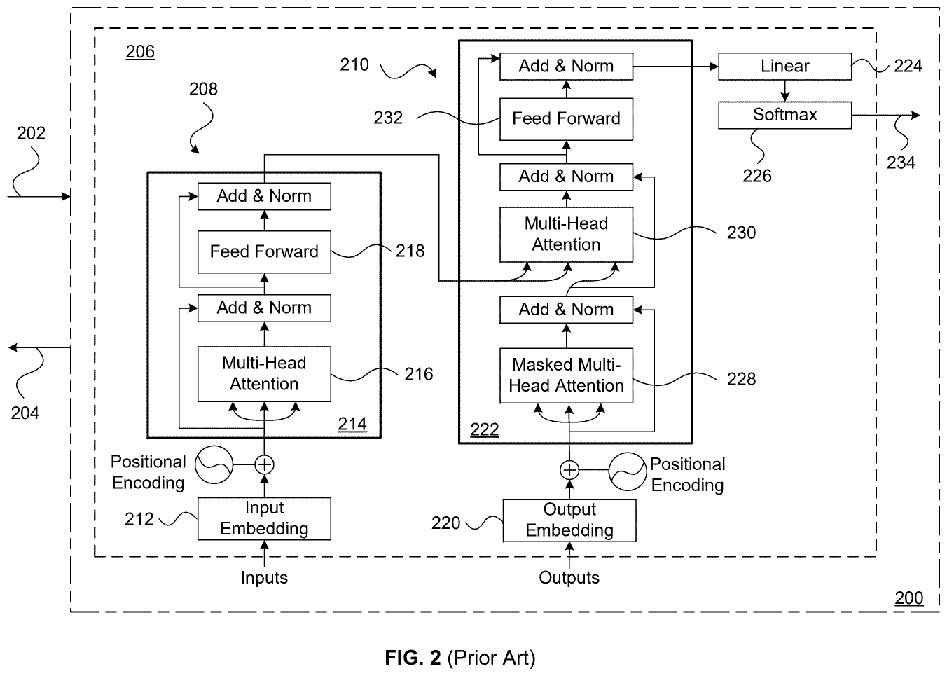

By way of example only, a Transformer architecture is presented in FIG. 2. In particular, system 200 of FIG. 2 is implementable as computer programs by processors of one or more computers in one or more locations. The system 200 receives an input sequence 202 and processes the input sequence 202 to transduce the input sequence 202 into an output sequence 204. The input sequence 202 has a respective network input at each of multiple input positions in an input order and the output sequence 204 has a respective network output at each of multiple output positions in an output order.

System 200 can perform any of a variety of tasks that require processing sequential inputs to generate sequential outputs. System 200 includes an attention-based sequence transduction neural network 206, which in turn includes an encoder neural network 208 and a decoder neural network 210. The encoder neural network 208 is configured to receive the input sequence 202 and generate a respective encoded representation of each of the network inputs in the input sequence. An encoded representation is a vector or other ordered collection of numeric values. The decoder neural network 210 is then configured to use the encoded representations of the network inputs to generate the output sequence 204. Generally, both the encoder 208 and the decoder 210 are attention-based. In some cases, neither the encoder nor the decoder includes any convolutional layers or any recurrent layers. The encoder neural network 208 includes an embedding layer (input embedding) 212 and a sequence of one or more encoder subnetworks 214. The encoder neural 208 network may N encoder subnetworks 214.

The embedding layer 212 is configured, for each network input in the input sequence, to map the network input to a numeric representation of the network input in an embedding space, e.g., into a vector in the embedding space. The embedding layer 212 then provides the numeric representations of the network inputs to the first subnetwork in the sequence of encoder subnetworks 214. The embedding layer 212 may be configured to map each network input to an embedded representation of the network input and then combine, e.g., sum or average, the embedded representation of the network input with a positional embedding of the input position of the network input in the input order to generate a combined embedded representation of the network input. In some cases, the positional embeddings are learned. As used herein, “learned” means that an operation or a value has been adjusted during the training of the sequence transduction neural network 206. In other cases, the positional embeddings may be fixed and are different for each position.

The combined embedded representation is then used as the numeric representation of the network input. Each of the encoder subnetworks 214 is configured to receive a respective encoder subnetwork input for each of the plurality of input positions and to generate a respective subnetwork output for each of the plurality of input positions. The encoder subnetwork outputs generated by the last encoder subnetwork in the sequence are then used as the encoded representations of the network inputs. For the first encoder subnetwork in the sequence, the encoder subnetwork input is the numeric representations generated by the embedding layer 212, and, for each encoder subnetwork other than the first encoder subnetwork in the sequence, the encoder subnetwork input is the encoder subnetwork output of the preceding encoder subnetwork in the sequence.

Each encoder subnetwork 214 includes an encoder self-attention sub-layer 216. The encoder self-attention sub-layer 216 is configured to receive the subnetwork input for each of the plurality of input positions and, for each particular input position in the input order, apply an attention mechanism over the encoder subnetwork inputs at the input positions using one or more queries derived from the encoder subnetwork input at the particular input position to generate a respective output for the particular input position. In some cases, the attention mechanism is a multi-head attention mechanism as shown. In some implementations, each of the encoder subnetworks 214 may also include a residual connection layer that combines the outputs of the encoder self-attention sub-layer with the inputs to the encoder self-attention sub-layer to generate an encoder self-attention residual output and a layer normalization layer that applies layer normalization to the encoder self-attention residual output. These two layers are collectively referred to as an “Add & Norm” operation in FIG. 2.

Some or all of the encoder subnetworks can also include a position-wise feed-forward layer 218 that is configured to operate on each position in the input sequence separately. In particular, for each input position, the feed-forward layer 218 is configured receive an input at the input position and apply a sequence of transformations to the input at the input position to generate an output for the input position. The inputs received by the position-wise feed-forward layer 218 can be the outputs of the layer normalization layer when the residual and layer normalization layers are included or the outputs of the encoder self-attention sub-layer 216 when the residual and layer normalization layers are not included. The transformations applied by the layer 218 will generally be the same for each input position (but different feed-forward layers in different subnetworks may apply different transformations).

In cases where an encoder subnetwork 214 includes a position-wise feed-forward layer 218 as shown, the encoder subnetwork can also include a residual connection layer that combines the outputs of the position-wise feed-forward layer with the inputs to the position-wise feed-forward layer to generate an encoder position-wise residual output and a layer normalization layer that applies layer normalization to the encoder position-wise residual output. As noted above, these two layers are also collectively referred to as an “Add & Norm” operation. The outputs of this layer normalization layer can then be used as the outputs of the encoder subnetwork 214.

Once the encoder neural network 208 has generated the encoded representations, the decoder neural network 210 is configured to generate the output sequence in an auto-regressive manner. That is, the decoder neural network 210 generates the output sequence, by at each of a plurality of generation time steps, generating a network output for a corresponding output position conditioned on (i) the encoded representations and (ii) network outputs at output positions preceding the output position in the output order. In particular, for a given output position, the decoder neural network generates an output that defines a probability distribution over possible network outputs at the given output position. The decoder neural network can then select a network output for the output position by sampling from the probability distribution or by selecting the network output with the highest probability.

Because the decoder neural network 210 is auto-regressive, at each generation time step, the decoder network 210 operates on the network outputs that have already been generated before the generation time step, i.e., the network outputs at output positions preceding the corresponding output position in the output order. In some implementations, to ensure this is the case during both inference and training, at each generation time step the decoder neural network 210 shifts the already generated network outputs right by one output order position (i.e., introduces a one position offset into the already generated network output sequence) and (as will be described in more detail below) masks certain operations so that positions can only attend to positions up to and including that position in the output sequence (and not subsequent positions). While the remainder of the description below describes that, when generating a given output at a given output position, various components of the decoder 210 operate on data at output positions preceding the given output positions (and not on data at any other output positions), it will be understood that this type of conditioning can be effectively implemented using shifting.

The decoder neural network 210 includes an embedding layer (output embedding) 220, a sequence of decoder subnetworks 222, a linear layer 224, and a softmax layer 226. In particular, the decoder neural network can include N decoder subnetworks 222. However, while the example of FIG. 2 shows the encoder 208 and the decoder 210 including the same number of subnetworks, in some cases the encoder 208 and the decoder 210 include different numbers of subnetworks. The embedding layer 220 is configured to, at each generation time step, for each network output at an output position that precedes the current output position in the output order, map the network output to a numeric representation of the network output in the embedding space. The embedding layer 220 then provides the numeric representations of the network outputs to the first subnetwork 222 in the sequence of decoder subnetworks.

In some implementations, the embedding layer 220 is configured to map each network output to an embedded representation of the network output and combine the embedded representation of the network output with a positional embedding of the output position of the network output in the output order to generate a combined embedded representation of the network output. The combined embedded representation is then used as the numeric representation of the network output. The embedding layer 220 generates the combined embedded representation in the same manner as described above with reference to the embedding layer 212.

Each decoder subnetwork 222 is configured to, at each generation time step, receive a respective decoder subnetwork input for each of the plurality of output positions preceding the corresponding output position and to generate a respective decoder subnetwork output for each of the plurality of output positions preceding the corresponding output position (or equivalently, when the output sequence has been shifted right, each network output at a position up to and including the current output position). In particular, each decoder subnetwork 222 includes two different attention sub-layers: a decoder self-attention sub-layer 228 and an encoder-decoder attention sub-layer 230. Each decoder self-attention sub-layer 228 is configured to, at each generation time step, receive an input for each output position preceding the corresponding output position and, for each of the particular output positions, apply an attention mechanism over the inputs at the output positions preceding the corresponding position using one or more queries derived from the input at the particular output position to generate a updated representation for the particular output position. That is, the decoder self-attention sub-layer 228 applies an attention mechanism that is masked so that it does not attend over or otherwise process any data that is not at a position preceding the current output position in the output sequence.

Each encoder-decoder attention sub-layer 230, on the other hand, is configured to, at each generation time step, receive an input for each output position preceding the corresponding output position and, for each of the output positions, apply an attention mechanism over the encoded representations at the input positions using one or more queries derived from the input for the output position to generate an updated representation for the output position. Thus, the encoder-decoder attention sub-layer 230 applies attention over encoded representations while the decoder self-attention sub-layer 228 applies attention over inputs at output positions.

In the example of FIG. 2, the decoder self-attention sub-layer 228 is shown as being before the encoder-decoder attention sub-layer in the processing order within the decoder subnetwork 222. In other examples, however, the decoder self-attention sub-layer 228 may be after the encoder-decoder attention sub-layer 230 in the processing order within the decoder subnetwork 222 or different subnetworks may have different processing orders. In some implementations, each decoder subnetwork 222 includes, after the decoder self-attention sub-layer 228, after the encoder-decoder attention sub-layer 230, or after each of the two sub-layers, a residual connection layer that combines the outputs of the attention sub-layer with the inputs to the attention sub-layer to generate a residual output and a layer normalization layer that applies layer normalization to the residual output. These two layers being inserted after each of the two sub-layers, both referred to as an “Add & Norm” operation.

Some or all of the decoder subnetwork 222 also include a position-wise feed-forward layer 232 that is configured to operate in a similar manner as the position-wise feed-forward layer 218 from the encoder 208. In particular, the layer 232 is configured to, at each generation time step: for each output position preceding the corresponding output position: receive an input at the output position, and apply a sequence of transformations to the input at the output position to generate an output for the output position. The inputs received by the position-wise feed-forward layer 232 can be the outputs of the layer normalization layer (following the last attention sub-layer in the subnetwork 222) when the residual and layer normalization layers are included or the outputs of the last attention sub-layer in the subnetwork 222 when the residual and layer normalization layers are not included. In cases where a decoder subnetwork 222 includes a position-wise feed- forward layer 232, the decoder subnetwork can also include a residual connection layer that combines the outputs of the position-wise feed-forward layer with the inputs to the position-wise feed-forward layer to generate a decoder position-wise residual output and a layer normalization layer that applies layer normalization to the decoder position-wise residual output. These two layers are also collectively referred to as an “Add & Norm” operation. The outputs of this layer normalization layer can then be used as the outputs of the decoder subnetwork 222.

At each generation time step, the linear layer 224 applies a learned linear transformation to the output of the last decoder subnetwork 222 in order to project the output of the last decoder subnetwork 222 into the appropriate space for processing by the softmax layer 226. The softmax layer 226 then applies a softmax function over the outputs of the linear layer 224 to generate the probability distribution (output probabilities) 234 over the possible network outputs at the generation time step. The decoder 210 can then select a network output from the possible network outputs using the probability distribution.

### Example Training Pipeline

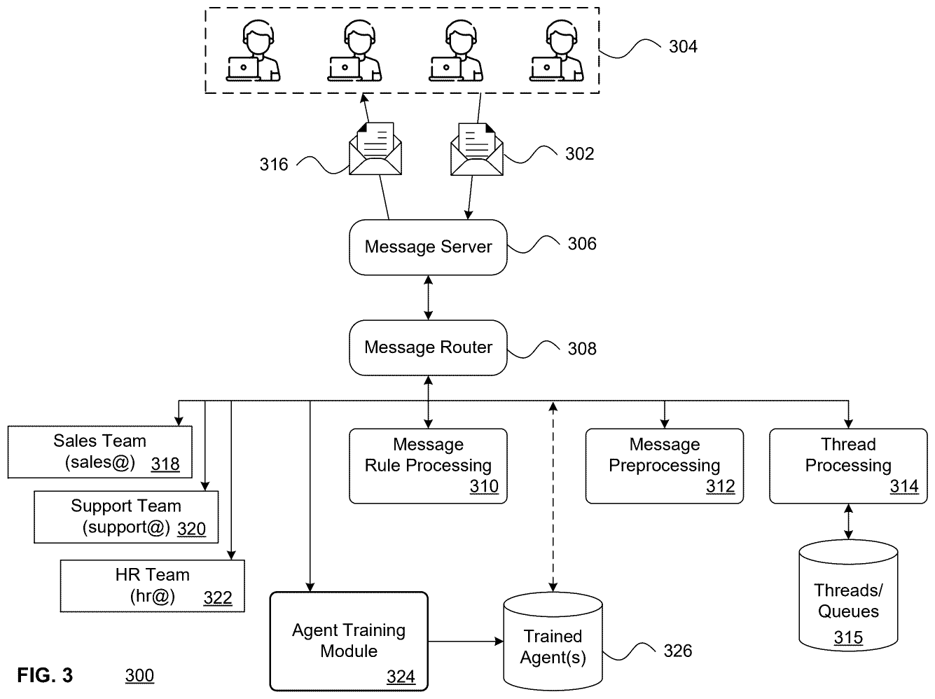

FIG. 3 illustrates an example training pipeline 300 for an autonomous LLM-type agent. For purposes of this example, reference is made to email messages. However, other types of electronic messages (e.g., chats, instant messages, or the like) could be used alternatively or additionally to email messages in order to train the agent. As shown, an incoming email 302 enters the system from the outside world (e.g., sent from one or more users 304) via a messaging server 306. The messaging server 306 may be, by way of example, a simple mail transfer protocol (SMTP) server, although other types of messaging servers may be employed.

The messaging server 306 is, in this scenario, the interface to the outside world (e.g., to the users 304). It passes incoming emails 302 to a message router 308, and outgoing messages from the message router to the users. The message router 308 may route a given incoming email 302 to one or more modules, as well as to one or more inboxes. For instance, the given email may be routed to a message rule processing module 310, a message preprocessing module 312 and/or a thread processing module 314.

The message rules processing module 310 can manage one or more rules that indicate to which inboxes or groups of people the incoming message will be sent. In a training scenario, one rule may be to train on data that comes to a specific email address (e.g., support@). This may cause a copy of that email to be sent to the training module. Another type of rule may be whether or how to preprocess an email message that can be used for training.

The preprocessing module 312 may be configured to perform certain operations on the incoming email message 302, such as one or more of removing headers, stripping out a signature line or signature block, deleting quoted text (e.g., prior message segments in an email thread, which may begin with a “>” character or other leading character(s)), discard ambiguous or malformed emails, remove attachments, etc. In another scenario, attachments may be used to help with training an LLM agent. For instance, if an attachment is determined to be relevant to a question (or answer), information corresponding to the attachment may be used as an input during agent training. Thus, in one scenario, an attachment (e.g., a PDF-, RTF- or DOCX-type text-based electronic document or other type of electronic document) can be preprocessed to extract content as a text string, which is then passed to the training process.

One goal of this preprocessing is to generate a clean quoting structure for use during agent training. The preprocessing module 312 may determine whether to discard certain portions of the email message. For instance, the module may focus on English and discard anything else, such as foreign language text, formulas or equations, etc. The module may remove certain content depending on encoding (e.g., whether Unicode is used or not). Moreover, multiple quoting levels may not make sense in a long email thread, so discarding may be helpful, whereas in-line responses may be easier to match answers to questions and therefore may not be discarded in some situations.

The thread processing module 314 may be configured to identify whether an incoming or outgoing message is part of a given thread, e.g., an outgoing message that is addressed to a particular outside recipient, who recently sent an incoming email to the messaging system. The thread processing module 314 may employ one or more timers or other features to correlate incoming and outgoing messages, in addition to matching email addresses. For instance, an incoming email from a particular user may be associated with a specific recipient inbox (e.g., Sales Team, Support Team, HR Team, etc.). When an outgoing email is sent from the specific recipient inbox to the particular user, the thread processing module 314 can identify that there is a message thread between the particular user and the specific recipient, or otherwise create a thread connection between them. By way of example, once an email comes in, the thread processing module 314 may put it into a queue, which is saved in memory (such as database 315) to keep track of the thread for a certain amount of time. The thread is based on a question or prompt in the first email from the user 304. The system can wait until it detects an answer, e.g., from one or more of the group inboxes.

Assume the incoming email contains a question, and the outgoing email (e.g., email message 316) contains an answer. For purposes of agent training, discussed further below, a question that gets no answers may be discarded after a “dormancy” threshold. A thread may be considered as “closed” or otherwise completed one dormancy period after the last email in the thread. Once the thread is completed, then it may be used in agent training. The dormancy threshold may be a specific timeframe, such as one or more days, a week, or longer or shorter. The dormancy threshold may be configurable, and may vary depending on the type of question, specific recipient inbox, and/or other factors.

Additionally or alternatively, using both temporal proximity and sentence structure analysis for example, the system may determine whether an answer was within an acceptable time period to consider whether the thread is active or closed. By way of example, machine learning can be used to both a) determine the average length of time between responses of this nature to determine if it is likely that this thread should remain open, and b) look for indications of time extension, such as “We will respond in X days” or “Our office is closed for the holiday weekend” to determine if the “open” status should remain as such. Thus, in one aspect the model may auto-tune over time. Also, if the most recent response contains a follow-up question, it may be determined that the thread is still open. Or, alternatively, if the time proximity is exceeded and the most recent response is a statement, or if an annotation indicates the action item is closed, the thread can be deemed closed.

Once any of the processing modules (e.g., modules 310, 312 and/or 314) process a given email message, that email message can be sent to the message router 308. As indicated above, the input email messages, or processed versions of those messages, may be routed to one or more shared inboxes or group email addresses via the message router 308. As shown in the example of FIG. 3, this may include a Sales Team (“sales@”) 318, a Support Team (“support@”) 320, an HR Team (“hr@”) 322, etc. In addition, if training is permitted using the message, then a copy is sent to an agent training module 324.

Message preprocessing 312 or another module in the messaging system can organize discrete incoming emails into threads, such as by using the Subject line and/or other headers that mail clients provide. According to one aspect of the technology, the system can use its ordering of the mail thread to infer that a reply (e.g., message #2) to an incoming email (e.g., message #1) is an answer to a question. This inference can be intensified in the model, for instance, if there is a literal question-mark in the reply. The inference could also be intensified by evaluating contextual information in the reply (e.g., a question from the incoming email is repeated, followed by a response) and/or other indicia (e.g., a thinking emoji or an answer emoji).

In many instances, the simplest or “cleanest” training data may come from simple question-answer pairs of messages. However, multiple reply messages, or a back-and-forth message chain, may help intensify the inference. Moreover, when multiple people reply to the same question, this can be helpful from a training perspective. Such messages may also be used by the model to more clearly identify the specific question (or questions) that has been posed. As noted above, a dormancy threshold can be used by the system to determine how long to wait for replies before including them (or discarding them) in the learning process.

Common questions can be expected to be repeat many times, and such common questions may be prioritized to train on first. Esoteric or complex message threads may not add much for training purposes, and thus may be discarded from a training data set. By way of example, the agent training module may evaluate whether a message thread has become too “messy” and unsuitable for training using a heuristic or other criteria. For instance, the heuristic may evaluate whether there is any interleaving of quotes and/or a total reply count. When a threshold level of interleaving and/or the total reply count exceeds a predetermined number (e.g., 3 or more replies), then the module in this example would flag that message as being too messy and then discard it from the training data set.

Once any processing has been performed by modules 310, 312 and/or 314, and when a set of input and responsive messages are part of a completed thread, then they may be passed to the agent training module 324. By way of example, one or more “closed” or otherwise completed threads in the database 315 may be passed to the agent training module 324.

The machine learning model may be trained with a huge corpus of data based on incoming and outgoing messages, e.g., using thousands, tens of thousands or more of messages as the training data set. This can be done autonomously without human intervention, once relevant message threads are selected by the system. The system can identify specific questions and answers to those questions, both of which can be used as training inputs to the LLM. By way of example, for each input email 302 and response 316, one or more of the processors of the system may automatically identify the corresponding question and answer, which may be used in the training either as inputs or as a check on the quality of the training results. The LLM foundation model should already “know” different ways of phrasing questions due to its initial training, thus the fine-tuning using specific question-answer pairs need not learn such phrasing.

The processor(s) of the system may be configured to detect one or more questions in a given (email) thread. The processor(s) may also determine if that email thread includes one or more answers responding to each detected question. Questions and answers in each email (or other message format) may include, but not limited to, text, URLs or URIs, emoji such as a smiley or confused face, and graphics. The processor(s) may identify all questions and answers to all the questions in the email thread. The processor(s) may generate a summary of one or more key issues of the email thread based on the detected question(s) and answer(s). Machine learning can be used when generating the summary.

### Example Training Approaches

In a first training scenario, the system focuses on training for “first-touch resolution”, such as where one question elicits one answer and there are no further responses (no further turns or back-and-forth communication). These answers may be trained to be informational for the specific question, rather than side-effects-based, such as to address issues that are off-topic from that question.

In a second training scenario, the system trains on multiple back-and-forth answers between the same 2 users, which further builds the conversational element. Here, there may be follow-up questions, which may help refine the answer. For instance, if the original question was “why does my tv not turn on when use the remote?”, the original answer may include things for the user to check (e.g., “are there batteries in the remote?”, “is the infrared receiver on the tv blocked by an object?”, etc.) The follow-up from the user may address the original answer and ask a more specific or different question (e.g., “what size batteries go in the remote?”, “do I have to point the remove directly at the tv?”, etc.). This, in turn, may result in a refined answer, such as: “use 3 AAA batteries, but make sure they are pointed in the directions as indicated in the battery receptacle”).

The initial answer (or some follow-up answer) may result in another question from the user that may be off-topic from the original question. For instance, the original email to a sales team may be “what is the price of the 64-bit processor?”, or the original email to a human resources team may be “what is the maximum I can contribute to my 401k next year?”. The follow-up email to the sales team may be “what solid-state flash memory sizes are compatible with the processor?”, while a follow-up email to the HR team may be “does the amount I contributed to my 401k this year impact my healthcare benefits next year?”. In such cases, the system may determine whether to ignore the new question for training entirely, use it for refinement training on sets of questions and answers, or identify this as the start of a new thread to train for a new question/answer pair.

The module 324 may evaluate one or more quality metrics that can be used for model reinforcement. By way of example, the system may consider quality metrics received in response to the answers provided to the users, which may be, e.g., a thumbs up/down indicator, a star rating system (e.g., out of 5 stars), smiley or frowny emojis, or the like, to confirm/validate quality of the answer. The module 324 may boost the weights for the messages (such as answer emails) that receive a thumbs up, 4-5 stars, or a smiley face. Thus, the system can reinforce training based upon the quality of the generated answer.

Once the agent training module 324 completes training of an LLM agent, that trained agent may be stored in a database, such as database 326 of FIG. 3. Once trained, the LLM agent may be used in different ways, and can interact (see dashed arrow) with the message router 308 to receive questions and generate answers. It may also forward questions it cannot suitably answer to a relevant group email address or a specific person. For example, it may be employed as a chatbot for interacting with customer or other users of a system. In arrangements that employ a shared mailbox (like a support ticket queue), the agent may, over time, be refined with further training. Then it could be used to take over an increasing percentage of support tickets, letting support agents handle more complicated issues. For a whole department, the agent can train on messages between humans and mailing lists, and gradually build answers to recurring questions. These can then be prompted during mail initiation, thereby acting as an electronic team assistant.

In one scenario, the agent may learn to address different types of questions. In another scenario, different agents may learn to address specific questions or are otherwise tailored to handle different types of questions. Thus, one agent may be configured to handle sales-related questions, another agent may be configured to handle IT-related questions, and a further agent may be configured to handle HR-related questions. Therefore, one or more trained agents may be stored as shown in the database 326.

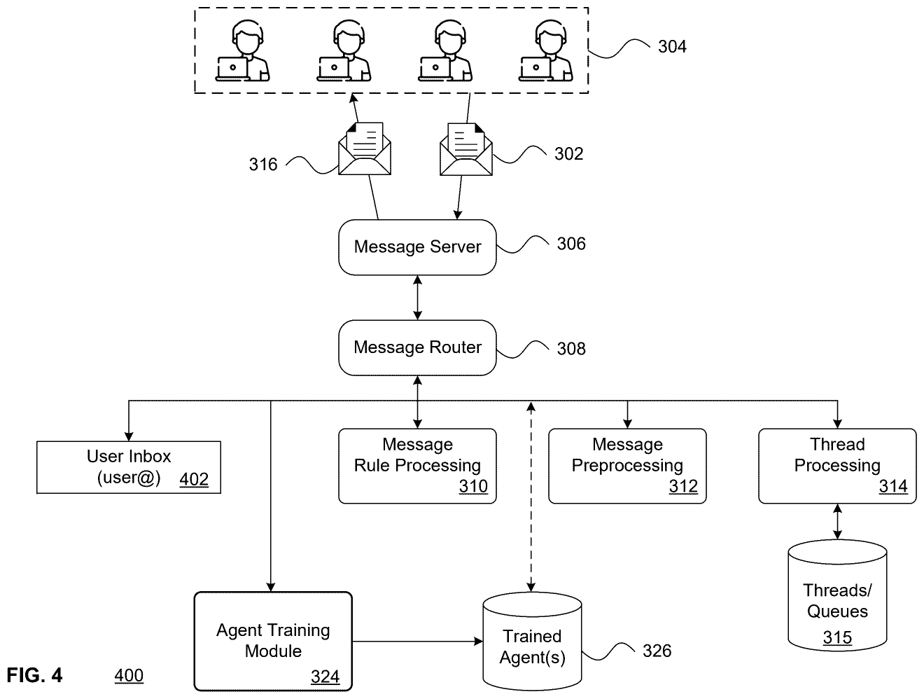

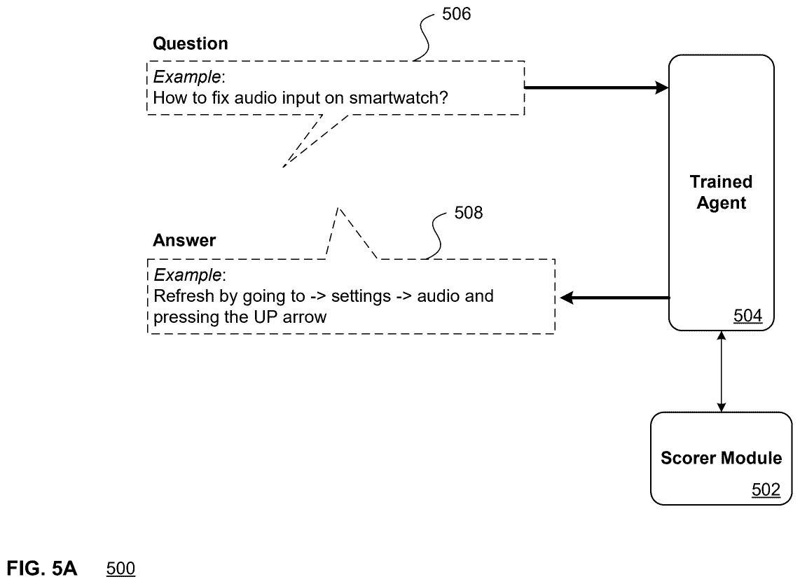

FIG. 4 illustrates another training pipeline configuration 400 that can be used to train on messages associated with a single person. By way of example, the system can build an agent based on a user's own electronic messages. This trained agent may be employed as a virtual assistant for that user. This configuration is similar to the one in FIG. 3. However, because it is for a single user, only a single inbox 402 as show. As with FIG. 3, the message router may pass messages to the different modules 310, 312 and 314, as well as to the agent training module 324 and the user's inbox 402. The agent training may be performed in any of the ways described above. Alternatively or additionally, the user may select which messages/threads or mailing lists, threads or questions/answers are to be used for bespoke agent training.

Alternatively or additionally to the various configurations discussed above, the system may include a scorer module. The scorer module can be used to evaluate an answer generated by a trained agent (or during training of an agent), in order to determine whether the answer should be provided in response to the question. If the determination is that the answer does not satisfy one or more question-answer criteria, then the answer may be discarded and/or the question may be forwarded to a human specialist so that it can be addressed. Various scoring techniques can be used, either alone or in combination, to identify a hallucination or error in an answer, such as binary scoring, count scoring, F1 or frequency scoring, term frequency-inverse document frequency scoring, pseudo-log likelihood scoring, etc.

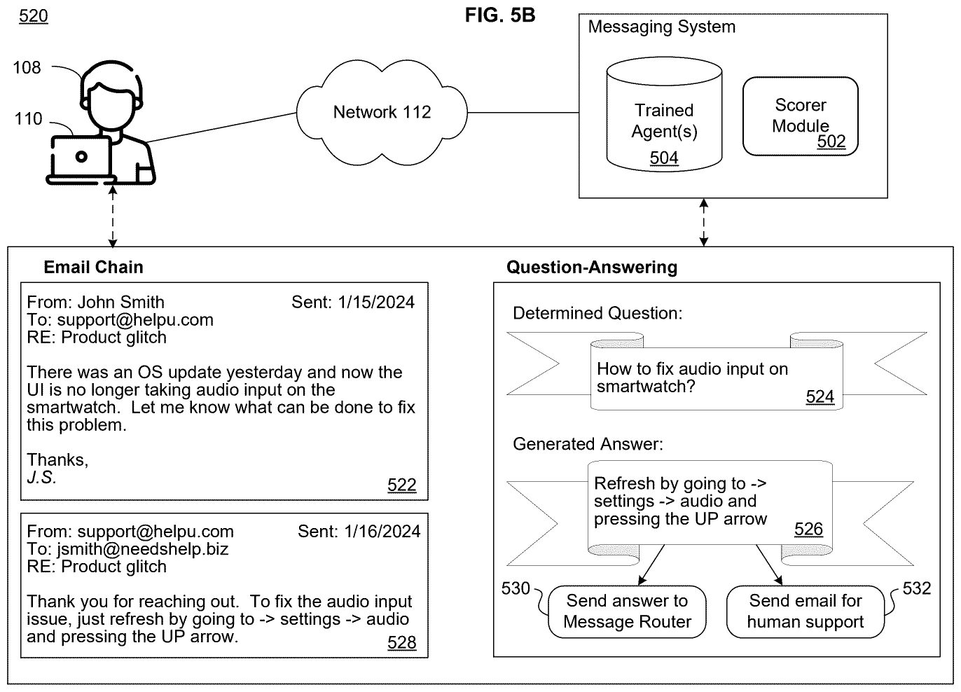

FIG. 5A illustrates an example 500 where a scorer module 502 can be used to evaluate answers generated by a trained agent 504. In this example, the trained agent 504 receives a question 506, e.g., as part of an email from a message router, such as message router 308. The trained agent 504 then generates answer 508. The scorer module 502 evaluates the answer 508 to determine whether it satisfies one or more threshold criteria. Note that the scorer module 502 may use, as input for the evaluation, prior feedback from users who posed the same or an equivalent question. Such prior feedback may include, as noted above, a thumbs up/down indicator, a star rating system, emojis, or the like, as well as written or audible feedback that communicated whether a particular answer was satisfactory for the user's question.

When the answer 508 satisfies the requirements, then answer can then be packaged as part of an email or other electronic response (e.g., chat or instant message) and sent to the message router for transmission by a corresponding message server, such as message server 306. However, when the answer 508 does not satisfy the requirements, such as because the answer is a hallucination or otherwise is unsatisfactory given the question, then the system may cause the corresponding input email or other electronic message with the question to be routed to an appropriate group inbox or specific email address of a person in order to address the question. For instance, the scorer module 502 may cause an email with the question to be routed to Sales Team (“sales@”) inbox 318, Support Team (“support@”) inbox 320, or HR Team (“hr@”) inbox 322. Moreover, the scorer module 502 may flag the email or the specific question for elevated response. This may indicate that the automated agent was unable to respond to the question. By way of example, this flag may be incorporated into the body of the forwarded message, such as by highlighting the question posed, in the subject line, or in an attachment to the forwarded message.

FIG. 5B illustrates a scenario 520 similar to the example of FIG. 1, but illustrating how a question-answer situation may be handled with a trained agent and a scorer module. Similar to FIG. 1, input email message 522 is received from a user, e.g., via messaging server 306 of FIG. 3. Then a message router, such as router 308, passes the message 522 to a trained agent 504. Here, the trained agent determines the question, as shown at 524. The trained agent also generates an answer, as shown at 526. Here, scorer module 502 can evaluate the quality of the answer. When it passes the evaluation (or in the case of no evaluation), the system then creates an electronic message 528. The system may then send the electronic message to the message router, as shown at block 530. Otherwise, when the message quality falls below a threshold or otherwise is nixed by the scorer module 502, the system may forward the received electronic message and its question to a corresponding inbox or other location as shown at block 532.

### Example System and Method

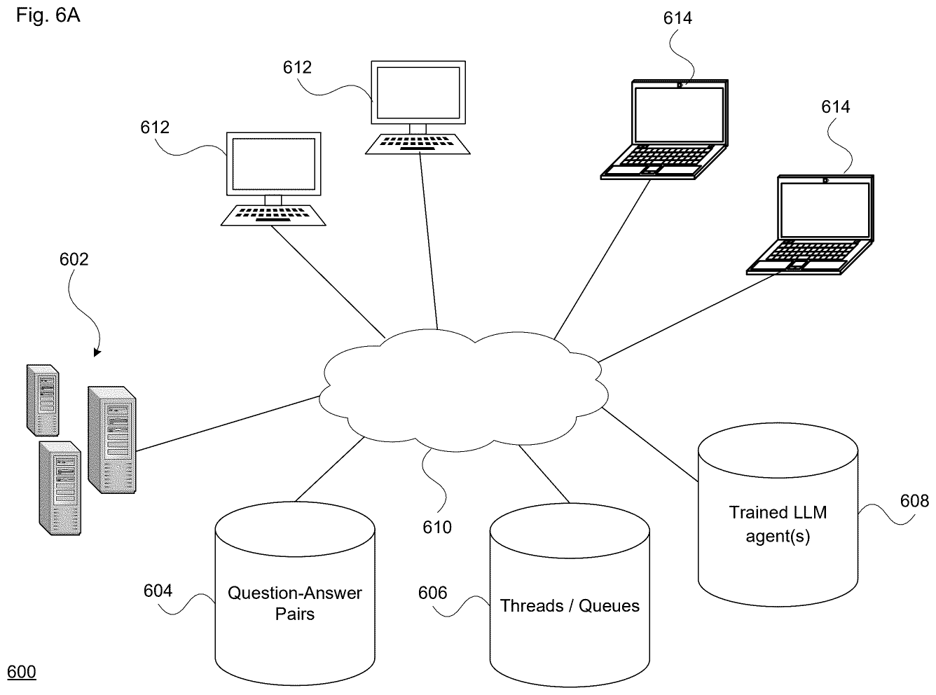

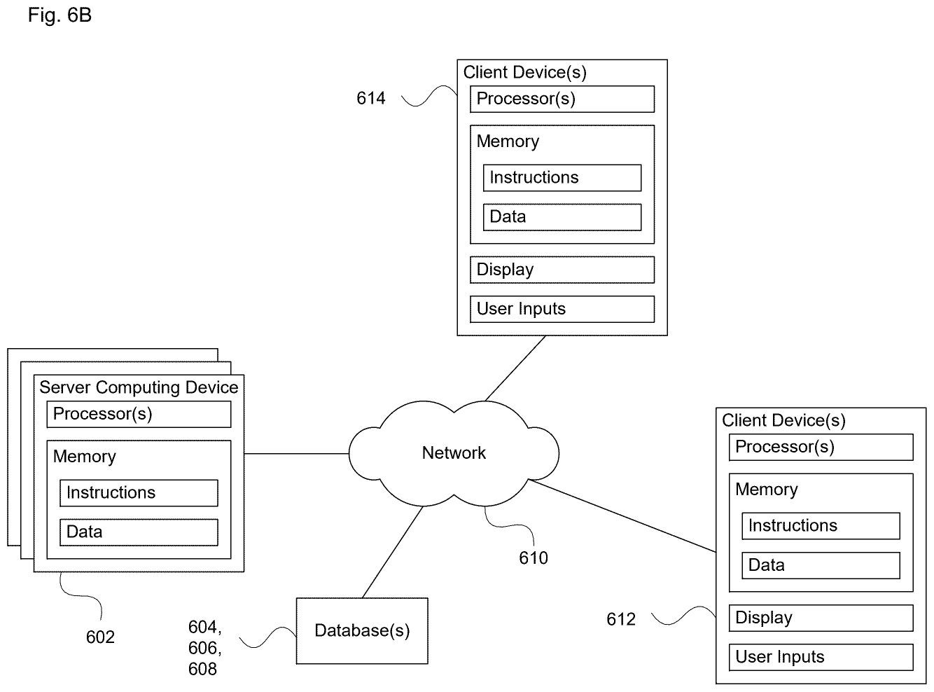

The autonomous LLM agents described herein may be trained on one or more tensor processing units (TPUs), graphics processing units (GPUs), CPUs or other computing architectures. One example computing architecture is shown in FIGS. 6A and 6B. In particular, FIGS. 6A and 6B are pictorial and functional diagrams, respectively, of an example system 600 that includes a plurality of computing devices and databases connected via a network. For instance, computing device(s) 602 may be a cloud-based server system that can be used for training pipeline 300 or 400. The computing device(s) 602 may implement the message server 306, the message router 308, and the processing modules 310, 312 and 314. The device(s) 602 may also host the various inboxes 318, 320, 322 and/or 402. Moreover, these devices may be configured to implement the agent training module 324.

Databases 604, 606 and 608 may store, e.g., question-answer pairs, threads/queues for messages, and/or trained LLM agents, respectively. The server system may access the databases via network 610. Client devices may include one or more of a desktop computer 612 and a laptop or tablet PC 614. In a support agent scenario, the computers 612 may be agent or employee devices that respond to user queries, while the computers 614 may be external devices of users who ask email or otherwise submit questions. In a team assistant scenario, the computers 612 and 614 may all be part of the same enterprise. Moreover, each such device in this scenario may pose questions, provide answers, or both. In the personal agent scenario, there may be one or more client computing devices 612 of the user, while computers 614 are managed by other people that submit questions and/or provide answers to questions from the user of the computing devices 612. Once an autonomous LLM agent has been trained as discussed herein, it may be implemented by the servers, computing devices 612 and/or computing devices 614 to respond to user questions.

As shown in FIG. 6B, each of the computing devices 602 and 612-614 may include one or more processors, memory, data and instructions. The memory stores information accessible by the one or more processors, including instructions and data that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing, whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs, TPUs, GPUs, etc. Alternatively, each processor may be a dedicated device such as an ASIC or other hardware-based processor. Although FIG. 6B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 602. Accordingly, references to a processor or computing device will be understood to include references to a collection of processors or computing devices or memories that may or may not operate in parallel.

Reference to “one or more processors” herein includes situations where a set of processors (e.g., two or more CPUs, TPUs, GPUs or any combination thereof) may be configured to perform one or more operations. Any combination of such a set of processors may perform individual operations or a group of operations. Therefore, reference to “one or more processors” does not require that all processors in the set must perform all of the operations. Rather, unless expressly stated, any one (or different combinations) of the one or more processors may perform different operations when a set of operations is indicated. For instance, different processors may perform specific operations. For example, a first processor performs one or more iterations of the ray or path tracing process, while a second processors performs one or more iterations of the denoise diffusion process.

Received data, such as emails, chats, instant messages, etc., may be operated on by the modules, models and processes described herein. The client devices may utilize such information in various apps or other programs to perform question-answer operations, act as a virtual assistant, etc. The computing devices may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touch screen and/or microphone) and one or more display devices (e.g., a monitor having a screen or any other electrical device that is operable to display information (e.g., text, imagery and/or other graphical elements). Other output devices, such as speaker(s) may also provide information to users.

The user-focused types of computing devices (e.g., 612-614) may communicate with a back-end computing system (e.g., server 602) via one or more networks, such as network 610. The network 610, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 602 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 602 may include one or more server computing devices that are capable of communicating with any of the computing devices 612-614 via the network 610.

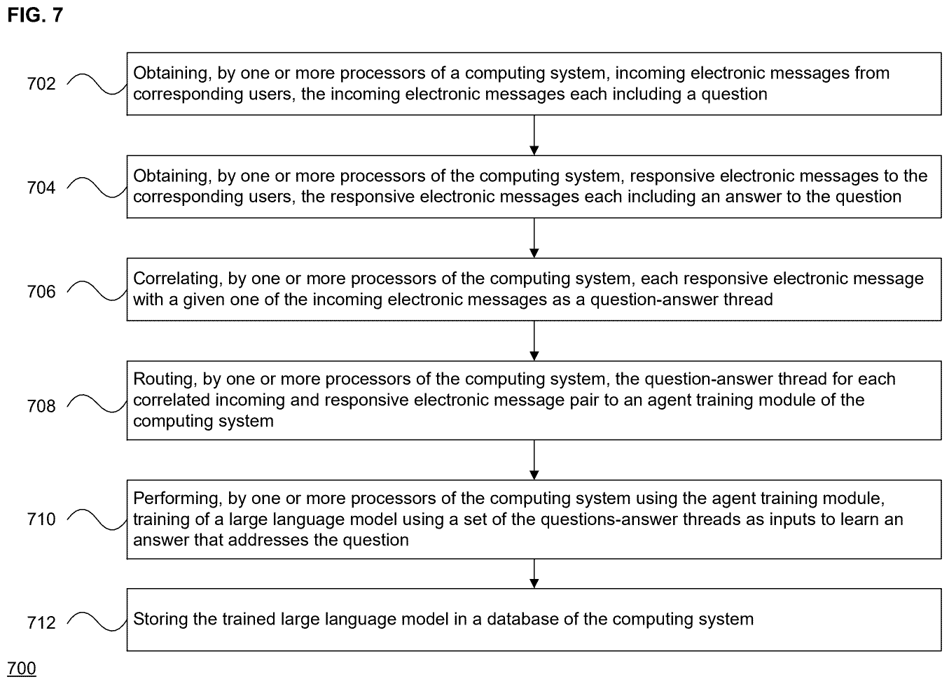

FIG. 7 illustrates a flow chart 700 illustrating an example process according to the approaches discussed herein. At block 702, the method includes obtaining, by one or more processors of a computing system, incoming electronic messages from corresponding users, the incoming electronic messages each including a question. At block 704, the method also includes obtaining, by one or more processors of the computing system, responsive electronic messages to the corresponding users, the responsive electronic messages each including an answer to the question. Then at block 706, the method includes correlating, by one or more processors of the computing system, each responsive electronic message with a given one of the incoming electronic messages as a question-answer thread. At block 708, the method includes routing, by one or more processors of the computing system, the question-answer thread for each correlated incoming and responsive electronic message pair to an agent training module of the computing system. At block 710, the method includes performing, by one or more processors of the computing system using the agent training module, training of a large language model using a set of the questions-answer threads as inputs to learn an answer that addresses the question. And at block 712, the method includes storing the trained large language model in a database of the computing system.

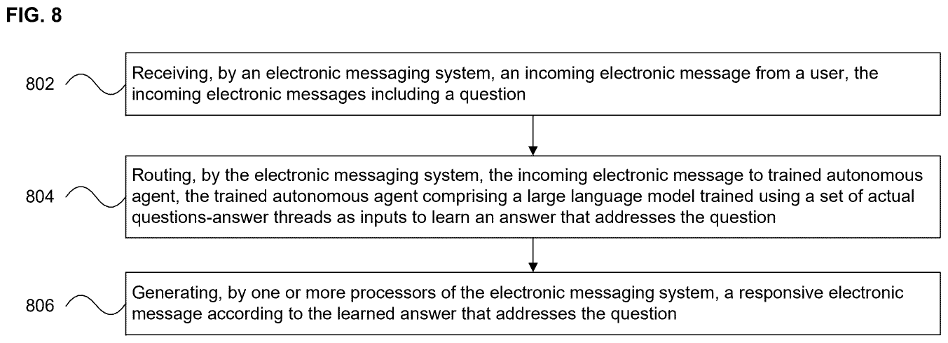

FIG. 8 illustrates a flow chart 800 illustrating another example process according to the approaches discussed herein. At block 802, the method includes receiving, by an electronic messaging system, an incoming electronic message from a user, the incoming electronic messages including a question. Then at block 804, the method includes routing, by the electronic messaging system, the incoming electronic message to trained autonomous agent. The trained autonomous agent comprises a large language model trained using a set of actual questions-answer threads as inputs to learn an answer that addresses the question. And at block 806 the method includes generating, by one or more processors of the electronic messaging system, a responsive electronic message according to the learned answer that addresses the question.

Further to the descriptions above, a user may be provided with controls allowing the user to make an election as to both if and when systems, programs, or features described herein may enable collection of user information (e.g., information about a user's email address, preferences, or current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Moreover, a user or a group of users, such as a sales team, support team, human resources team, etc., may be provided with controls enabling authorization to use email associated with that user or group during agent training. Thus, the user (or team of users) may have control over what information is collected about the user, how that information is used, and what information is provided to the user or to others.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A method, comprising:
obtaining, by one or more processors of a computing system, incoming electronic messages from corresponding users, the incoming electronic messages each including a question;
obtaining, by one or more processors of the computing system, responsive electronic messages to the corresponding users, the responsive electronic messages each including an answer to the question;
correlating, by one or more processors of the computing system, each responsive electronic message with a given one of the incoming electronic messages as a question-answer thread;
routing, by one or more processors of the computing system, the question-answer thread for each correlated incoming and responsive electronic message pair to an agent training module of the computing system;
performing, by one or more processors of the computing system using the agent training module, training of a large language model using a set of the questions-answer threads as inputs to learn an answer that addresses the question; and
storing the trained large language model in a database of the computing system.

2. The method of claim 1, wherein:
the correlating includes tracking each given incoming electronic message and each responsive electronic message for a selected amount of time; and
prior to routing the question-answer thread for each correlated incoming and responsive electronic message pair to the agent training module, discarding any subsequent messaged in that question-answer thread obtained after the selected amount of time.

3. The method of claim 1, wherein the correlating includes adding any new incoming message or new responsive message to a related question-answer thread when the new incoming or responsive messages are obtained before a dormancy threshold has been reached.

4. The method of claim 1, wherein the training of the large language model comprises fine-tuning a previously trained model for a specific question-answer situation.

5. The method of claim 1, wherein the responsive electronic messages are obtained from a shared inbox or group email address.

6. The method of claim 1, wherein the responsive electronic messages are associated with a single person.

7. The method of claim 6, wherein the trained large language model is configured for use as a virtual assistant for the single person.

8. The method of claim 1, further comprising preprocessing one or more of the incoming electronic messages or responsive electronic messages to remove selected information therefrom.

9. The method of claim 8, wherein removing the selecting information includes at least one of removing a signature block, removing quoted text, or removing an attachment.

10. The method of claim 1, wherein performing the training includes discarding a learned answer that does not satisfy a question-answer criterion.

11. A method, comprising:
receiving, by an electronic messaging system, an incoming electronic message from a user, the incoming electronic messages including a question;
routing, by the electronic messaging system, the incoming electronic message to trained autonomous agent, the trained autonomous agent comprising a large language model trained using a set of actual questions-answer threads as inputs to learn an answer that addresses the question; and
generating, by one or more processors of the electronic messaging system, a responsive electronic message according to the learned answer that addresses the question.

12. The method of claim 11, further comprising:
creating, by the trained autonomous agent, a proposed answer to the question; and
evaluating, by the one or more processors using a scorer module, the proposed answer.

13. The method of claim 12, wherein, when evaluating determines that the proposed answer does not satisfy a threshold criterion, the method further includes:
discarding the generated responsive electronic message; and
forwarding the incoming electronic message to a specific inbox or email address for manual answer generation.

14. The method of claim 12, wherein, when evaluating determines that the proposed answer does satisfy a threshold criterion, the method further includes:
causing the generated responsive electronic message to be transmitted to the user.

15. A system, comprising:
an electronic message module configured to obtain incoming electronic messages from corresponding users, the incoming electronic messages each including a question, and to obtain responsive electronic messages to the corresponding users, the responsive electronic messages each including an answer to the question;
a thread processing module configured to correlate each responsive electronic message with a given one of the incoming electronic messages as a question-answer thread; and
an agent training module configured to receive the question-answer thread for each correlated incoming and responsive electronic message pair, the agent training module being configured to train a large language model using a set of the questions-answer threads as inputs to learn an answer that addresses the question, and to store the trained large language model in a database of the computing system.

16. The system of claim 15, wherein:
the correlation includes tracking each given incoming electronic message and each responsive electronic message for a selected amount of time; and
for a subsequent messaged in a given question-answer thread obtained after the selected amount of time, the thread processing module is configured to discard the subsequent message.

17. The system of claim 15, wherein the correlation includes addition of any new incoming message or new responsive message to a related question-answer thread when the new incoming or responsive messages are obtained before a dormancy threshold has been reached.

18. The system of claim 15, wherein the agent training module is configured to train the large language model by fine-tuning a previously trained model for a specific question-answer situation.

19. The system of claim 15, wherein the system is further configured to preprocess one or more of the incoming electronic messages or responsive electronic messages to remove selected information therefrom.

20. The method of claim 1, wherein performance of the training includes discarding a learned answer that does not satisfy a question-answer criterion.
